(19) United States
(12) Patent Application Publication
(10) Pub. No.: US 2014/0033025 A1
(43) Pub. Date: Jan. 30, 2014

(54) DISPLAYING A TEXT-BASED DESCRIPTION OF DIGITAL CONTENT IN A SUB-FRAME

(71) Applicants: Anubhav Mukherjee, Delhi (IN); Narinder Beri, Jalandhar City (IN)

(72) Inventors: Anubhav Mukherjee, Delhi (IN); Narinder Beri, Jalandhar City (IN)

(73) Assignee: ADOBE SYSTEMS INCORPORATED

(21) Appl. No.: 11/951,493

(22) Filed: Dec. 6, 2007

(51) Int. Cl. G06F 17/00; G06F 3/00

(52) U.S. Cl. 715/246; 715/760

(57) ABSTRACT

In some example embodiments, a system and method is shown that includes receiving a text request that includes an identifier value that identifies a text-based description associated with a portion of digital content that is part of a larger portion of digital content. Further, the method includes responsive to the text request, retrieving the text-based description associated with the portion of digital content from a data store, the retrieving using the identifier value to identify the text-based description. Additionally, the method includes communicating the text-based description to a user.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be illustrated below and in the drawings that form a part of this document: Copyright © 2007, Adobe Systems Incorporated. All Rights Reserved.

### TECHNICAL FIELD

The present application relates generally to the technical field of algorithms and programming and, in one specific example, to the display of information relating to digital content.

### BACKGROUND

Digital content may have information associated with it in the form of, for example, close-captioned text, subtitles, or other suitable text appearing with the digital content on a display. This information may be a textual representation of audio portion of the digital content. This display may be a television, computer monitor, or other suitable display.

### BRIEF DESCRIPTION OF THE DRAWINGS

Some embodiments are illustrated by way of example and not limitation in the figures of the accompanying drawings in which:

FIG. 1 is a diagram of a system, according to an example embodiment, illustrating a setup, and subsequent transmission and receipt of a text-based description.

FIG. 2 is a diagram of a system, according to an example embodiment, illustrating the use of a web server to provide a text-based description to a media-player application.

FIG. 3 is a diagram of a media-player application User Interface (UI), according to an example embodiment, showing a text-based description.

FIG. 4 is a diagram of a media-player application UI, according to an example embodiment, illustrating dialogue text associated with a scene related to a portion of digital content.

FIG. 5 is a diagram of a media-player application UI, according to an example embodiment, illustrating a text-based description associated with a portion of digital content that has been provided as a complete file.

FIG. 6 is a diagram of a media-player application UI, according to an example embodiment, illustrating digital content in addition to text that may be displayed within a popup screen.

FIG. 7 is a diagram of a text-based description, according to an example embodiment, illustrating a text-based description encoded in an eXtensible Markup Language (XML) format.

FIG. 8 is a diagram of a text-based description, according to an example embodiment, illustrating basis for the text-based description, as a character delimited flat file.

FIG. 9 is a block diagram of an computer system, according to an example embodiment, used to generate a text request and to receive a text-based description.

FIG. 10 is a software architecture diagram, according to an example embodiment, illustrating various code modules associated with the one or more devices and a web server.

FIG. 11 is a flow chart illustrating a method, according to an example embodiment, wherein a plug-in may receive and process a signal from an input device.

FIG. 12 is a flow chart illustrating a method, according to an example embodiment, wherein a plug-in may receive a text-based description and display the contents (e.g., text) associated with the text-base description within a sub frame.

FIG. 13 is a flow chart illustrating a method, according to an example embodiment, showing how to request and display a text-based description.

FIG. 14 is a dual-stream flow chart illustrating a method, according to an example embodiment, that when implemented, displays a text-based description within a media-player application UI.

FIG. 15 is a flow chart illustrating a method, according to an example embodiment, used to execute a player engine.

FIG. 16 is a flow chart illustrating a method, according to an example embodiment, used to execute an operation that parses the content request and determines whether the text corresponding to the content request exists.

FIG. 17 is a flowchart illustrating a method, according to an example embodiment, used to execute an operation that parses the text-based description, and displays the portions of the parsed text-based description within one or more popup screens.

FIG. 18 is a Relational Data Schema (RDS), according to an example embodiment.

FIG. 19 shows a diagrammatic representation of a machine in the example form of a computer system, according to an example embodiment.

### DETAILED DESCRIPTION

In the following description, for purposes of explanation, numerous specific details are set forth in order to provide a thorough understanding of an example embodiment of the present invention. It may be evident, however, to one skilled in the art that the present invention will be practiced without these specific details.

In some example embodiments, a system and method is illustrated for using an input device to retrieve a description (e.g., textual, image, video or audio) relating to digital content. A text-based description may for example include not only text in the form of American Standard Code for Information Interchange (ASC-II) or Unicode based character(s), but may also include images, audio/video digital content, web links and other multi-media supported data. Further, this text-based description may be displayed on a screen (e.g., as part of a popup or persistent screen element) in conjunction with the playing of a portion of digital content. This portion of digital content may be part of a larger portion of digital content. For example, the portion of digital content may be a scene in a movie, where the movie is the larger portion of digital content.

Some example embodiments may include the display of this text-based description within a sub frame that is part of a larger frame. A frame or sub frame may be bounded viewing area in a display, in which the text-based description may be shown. In one example embodiment, a popup screen may be a sub frame that appears within another, larger frame. Larger may mean taking up more of a viewing area than a sub frame. The technologies used to create the popup screen are described below. Further, this popup screen may be part of a stand alone application media player application or a web based application such as a web-browser.

In other example embodiments, the text-based description alone may be displayed on the screen. An input device may be a mouse, light pen, keyboard, or other suitable input device. A text-based description may be text initially formatted as an XML file, a character delimited flat file, or some other suitably formatted file. Digital content may include video content or audio/video content formatted using, for example, the Moving Picture Experts Group (MPEG) codec, the H.261 codec, the H.263 codec, or some other suitable codec. Additionally, video content or audio/video content may include a Joint Photographic Experts Group (JPEG) formatted image, a Portable Network Graphics (PNG) formatted image, Graphics Interchange Format (GIF) formatted image, or some other suitably formatted image. Additionally, a FLASH™ formatted file may be utilized to format the audio or audio/video digital content.

Some example embodiments may include the use of a media-player application UI to display the text-based description as part of a display or UI element (e.g., a popup screen element or a persistent screen element). This media-player application may be, for example, a FLASH™ media-player, a WINAMP™ media-player, a WINDOWS™ media-player, or some other suitable media-player application. A popup screen (e.g., a sub frame within a larger frame in a display) may be generated to display the text-based description. This popup screen may be generated using, for example, Asynchronous JavaScript and XML (AJAX) technology, Dynamic Hyper Text Markup Language (DHTML) technology, Hyper Text Markup Language (HTML), XML, or some other suitable technology to display text on a screen. This popup screen may be a screen object or widget. This popup screen may appear in close proximity to, or be attached to, a timeline toolbar that exists as part of a media-player application. In some example embodiments, a timeline toolbar of a video is a linear representation of the progress of a video from the first to the last video frame. A video frame may be a portion of video based digital content understood in terms Frames Per Second (FPS). Further, each frame may be referenced via temporal reference data (e.g., a temporal value or collection of temporal reference values). In some example cases, a temporal reference value is a field within an MPEG formatted data packet. In a UI for the media-player application, the timeline toolbar may be represented as a scrollbar that can receive mouse inputs. In some example embodiments, timeline tool bar may be some other type of screen object or widget used to display the time and/or sequence information for digital content. A user can move a slider (e.g., a time position) to jump to any frame in the video, using an input device.

In some example embodiments, when a mouse pointer is positioned over any point on the timeline toolbar of a streaming video, the video player may fetch a subtitle (e.g., a text-based description) from a subtitle file description of various time points in the video corresponding to that point, and display the subtitle in a tooltip (e.g., a popup screen). In some example embodiments, subtitles are textual versions of the dialogue in films, television programmes and other suitable digital content. Subtitles may, for example, be either a form of written translation of a spoken dialogue in a foreign language or a written rendering in the same language of dialogue taking place in audio/video content. Further, in some example embodiments, a media-player application playing the digital content (e.g., video) is able to receive events and handle them. These events may include a mouse-over event, a mouse down event (e.g., employed during the execution of a PLAY button), or other types of suitable events.

Some example embodiments may include a text-based description as a subtitle file. A user, in some example embodiments, may position UI pointer or selector using an input device, such as a mouse, and associated pointing device, on a point in the timeline toolbar of a video. A signal may be generated in the form of a mouse-over command to select the point in the timeline toolbar. This signal from the input device may then be processed such that a method may be executed to determine if there is a text-based description in the subtitle file corresponding to the selected point. This selected point may, in some example embodiments, may be a temporal reference value, or some other suitable value.

### Example System

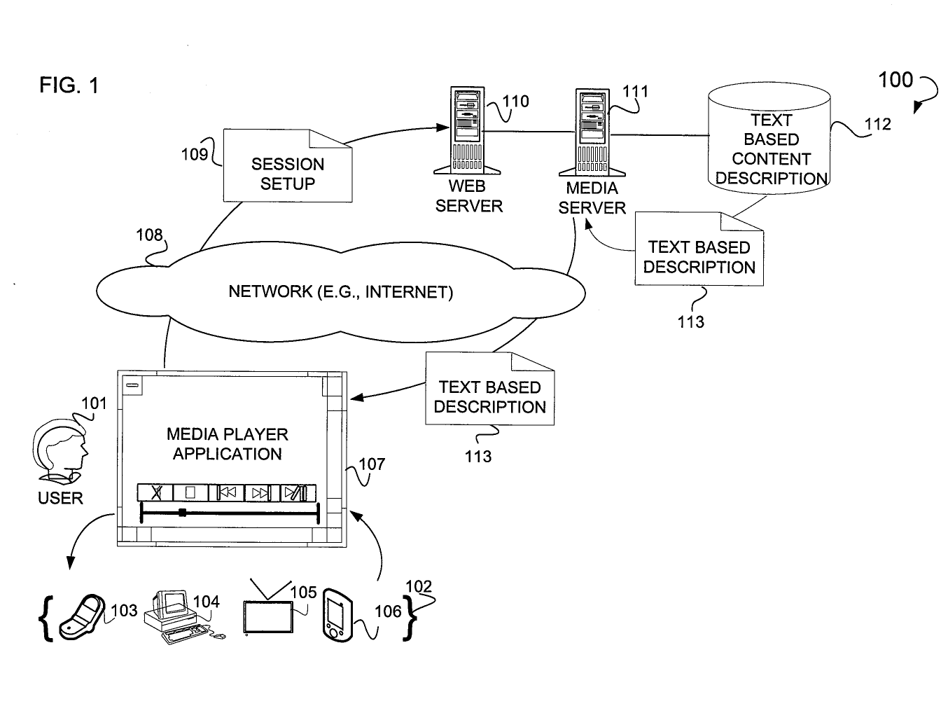

FIG. 1 is a diagram of an example system 100 illustrating a setup subsequent transmission, and receipt of a text-based description. This text-based description may relate to and describe a particular portion of digital content or portion thereof. Shown is a user 101 utilizing a media-player application UI 107. This media-player application UI 107 may reside on one or more devices 102. These devices 102 may include, for example, a cell phone 103, a computer system 104, a television 105, and/or a Personal Digital Assistant (PDA) 106. Utilizing this media-player application UI 107, the user 101 may generate a session setup 109 that may be transmitted across the network 108 to a web server 110. This session setup 109 may be, for example, a Hypertext Transfer Protocol (HTTP) formatted message that may seek to set up a media streaming session with the web server 110. Moreover, this session setup 109 may be a Real Time Streaming Protocol (RTSP) formatted message including a request to setup a media streaming session with the media server 111. A Transmission Control Protocol/Internet Protocol (TCP/IP) may be used with HTTP or RTSP to generate a session setup 107. A User Datagram Protocol (UDP) may be used with IP (UDP/IP) and HTTP or RTSP to generate a session setup 107.

This media streaming session may be set up between the one or more devices 102, and the web server 110, a media server 111, or a streaming server (not pictured). In other example embodiments, this session will be set up between the one or more devices 102, and, for example, a media server 111 or, for example, a streaming server (not pictured), or even the web server 110. Shown is the media server 111 operatively connected to the web server 110. Further, connected to the media server 111, is a text-based content description database 112. A database server (not pictured) may serve or act to mediate the relationship between the media server 111, and the text-based content description database 112. The media server 111 may query the text-based content description database 112 so as to retrieve a text-based description 113. This text-based description 113 may be transmitted back across the network 108 to the one or more devices 102. Once received by the one or more devices 102, the text-based description 113 may be displayed in, for example, the media-player application UI 107. This text-based description 113, and the data contained therein, may be displayed within a frame for the media-player application UI 107. Further, a new text-based description 113 may be requested from the media server 111 every time the user 101 executes, for example, a mouse-over operation. As is more fully described below, this text-based description 113 may be an XML file, a flat file, or some other suitably formatted file.

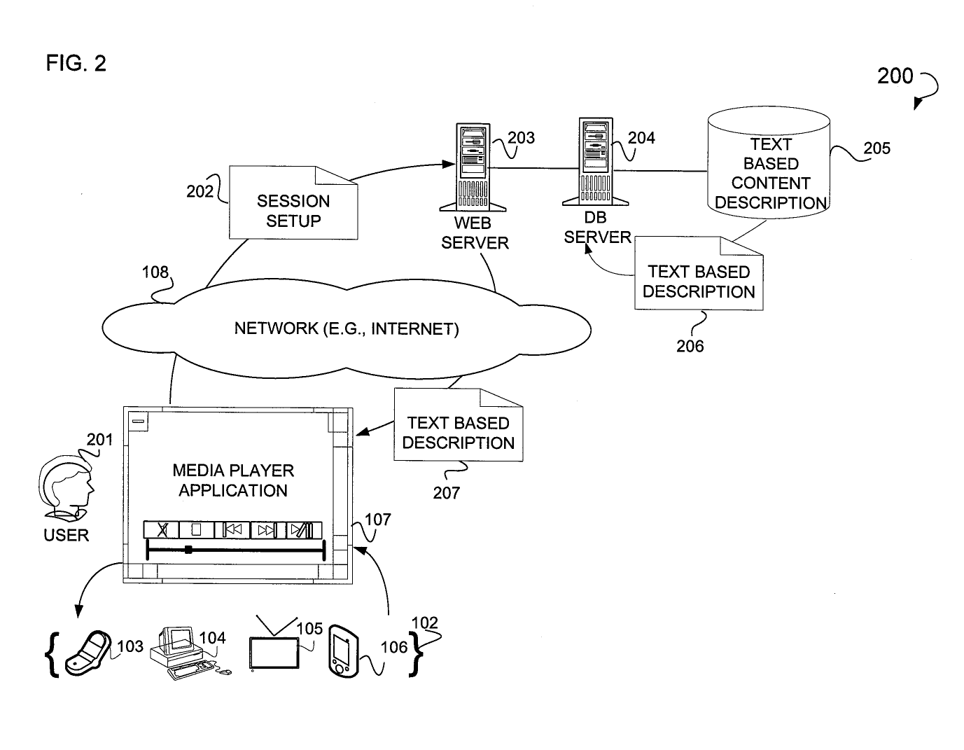

FIG. 2 is a diagram of an example system 200 illustrating the use of a web server 203 to provide a text-based description to a media-player application. Shown is a user 201 utilizing the media-player application UI 107 via one or more devices 102. In using this media-player application UI 107, the user 201 may generate, for example, a session setup 202 that may be transmitted across a network 108 to be received by a web server 203. The session setup 202 may be a TCP/IP or UDP/IP based session. This session setup 202 may also use HTTP and/or RTSP with TCP/IP and/or UDP/IP. This web server 203 may be operatively connected to a database server 204. Further, this database server 204 may be operatively connected to a text-based content description database 205. Some example embodiments may include, the database server 204 running a database application such as MYSQL™, SQLSERVER™, or some other suitable database application. The database server 204 implements a database application capable of utilizing (e.g., making queries) a Multidimensional Expression (MDX) language, and/or a Structured Query Language (SQL).

In some example embodiments, upon successfully completing a session setup, the web server 203 may transmit a text request to the database server 204, wherein the database server 204 will then retrieve the text referenced in the text request from the text-based content description database 205. A text request may be, for example, a data packet, or series of data packets, formatted using HTTP, and various function associated therewith. HTTP may, in some cases, be used with other languages and protocols such as SQL, or MDX so as to retrieve the data outlined in the text request. In response to this request, a text-based description 206 may be provided to the database server 204. The database server 204 may then provide this text-based description 206 to the web server 203, wherein the web server 203 may format this text-based description 206 so as to generate the text-based description 207. This formatting may take a form of, for example, utilizing HTTP to transmit the text-based description 207 back across the network 108 to the media-player application UI 107. A new text-based description 207 may be requested from the web server 203 every time the user 201 performs, for example, a mouse-over operation. Once received by the media-player application UI 107, the text-based description 207 may be displayed to the user 201. As is more fully described below, the text-based description 207 may be an XML file, a flat file, or some other suitably formatted file.

### Example UI's

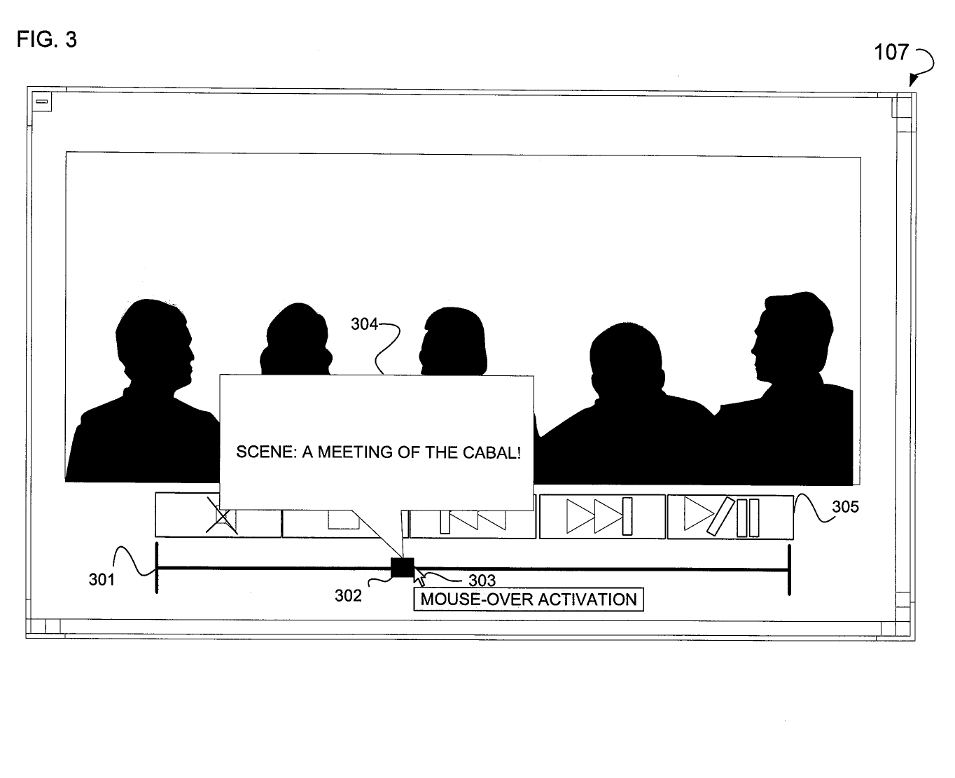

FIG. 3 is a diagram of an example media-player application UI 107 showing a text-based description. Illustrated is a media-player application UI 107 showing a popup screen 304, wherein this popup screen 304 displays text relating to a particular scene in a portion of digital content. Various screen objects or widgets are provided as a part of this media-player application UI 107. These screen objects or widgets allow for a user, such as user 101, or 201 to avail themselves of various functionalities associated with the media-player application UI 107. For example, a timeline toolbar 301 is shown that allows the user 101 to traverse through the displayed digital content based upon time or a timing sequence. Further, a time position 302 is also shown that denotes the time of a particular scene being displayed within the media-player application UI 107 relative to the entire portion of digital content. Further, the time of the particular scene may be relative to a selected start time within the entire portion of digital content. This start time may be selected using an input device and, for example, a mouse-over operation. Shown is a mouse pointer 303 that denotes a mouse-over activation as the basis for generating the popup screen 304. The mouse pointer 303 may be utilized without an on-screen description (e.g., “mouse-over activation”) of the basis for the generation of the popup screen 304. Also, a series of media-player application buttons 305 are displayed. These media-player application buttons 305 include screen objects and widgets relating to functionalities such as view, play, stop, pause, fast forward, and reverse.

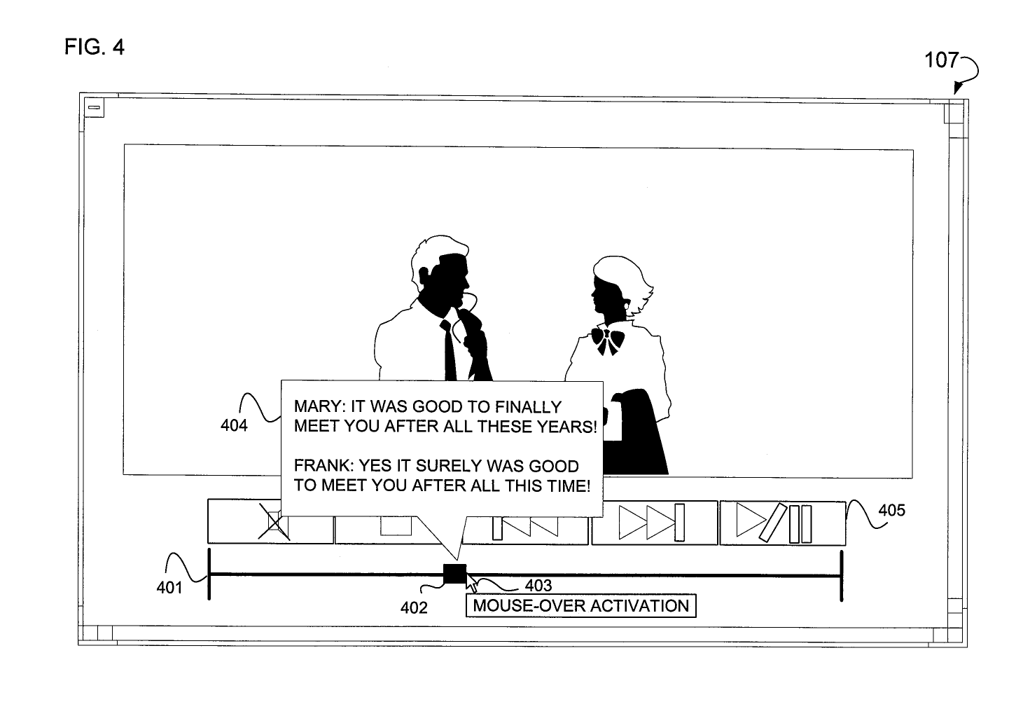

FIG. 4 is a diagram of an example media-player application UI 107 illustrating dialogue text associated with a scene that is a part of a piece of video digital content. Shown is a media-player application UI 107 containing various screen objects and widgets that relate to various functionalities that are available to operate this media-player application UI 107. For example, a timeline toolbar 401 is shown, a time position 402 is shown, and a collection of media-player application buttons 405 are shown. Further, a mouse pointer 403 is also shown. Using a mouse pointer 403, a user, such as user 101 or 201, may perform a mouse-over operation on a time position 402 such that a popup screen 404 is generated by the media-player application UI 107. Here, for example, shown within the popup 404 is dialogue text relating to the scene that is occurring within the media-player application UI 107.

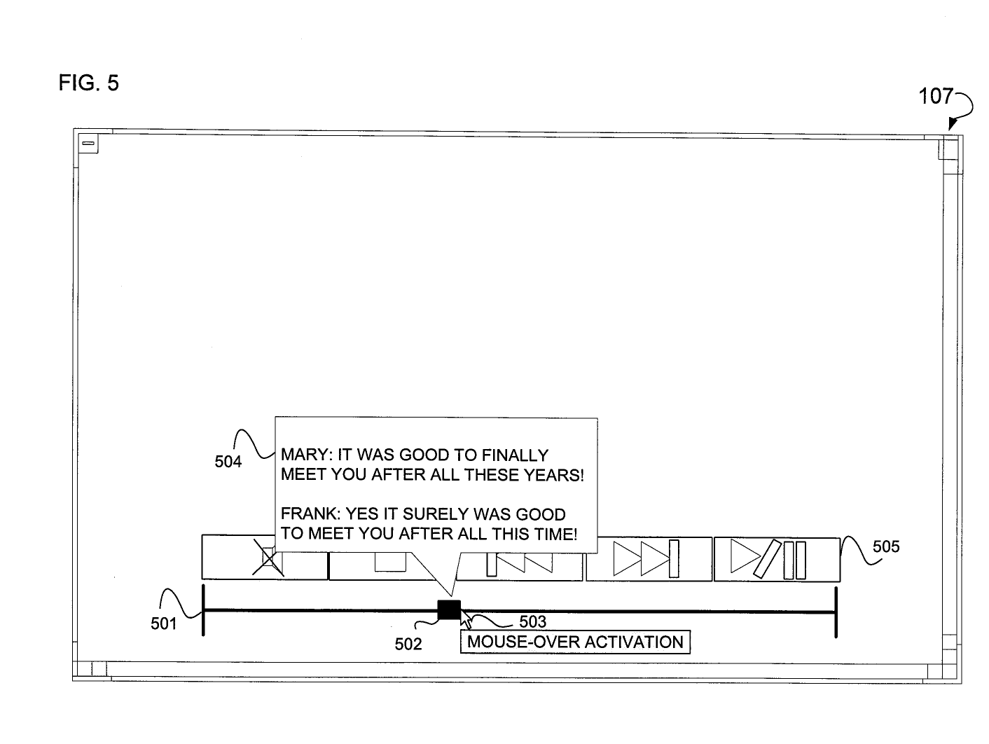

FIG. 5 is a diagram of an example media-player application UI 107 illustrating a text-based description, associated with a portion of digital content that has been provided as a complete file. Here a popup screen 504 is shown that resides as part of a media-player application. Displayed within this popup screen 504 is a text-based description relating to a portion of digital content. In contrast to FIG. 4, here no actual piece of video digital content is displayed along with the text-based description relating to the portion of digital content. Rather, only the text-based description for the digital content is displayed. As shown elsewhere, this text-based description may be displayed on an as needed basis. Specifically, when a user, such as user 101 or 201, selects the time position 502 existing along a timeline toolbar 501 a using a mouse pointer 503, only the text-based description for the particular time position 502 may be displayed. A mouse-over operation may be executed on the time position 502 to generate the popup screen 504. This text-based description may be displayed even in cases where the digital content has not been streamed, but rather is stored in a native data store residing on the one or more devices 102. Further, the user 101 or user 201 may use a series of media-player application buttons 505 to traverse the digital content and associated text-based description. In the alternative, the text-based description may be streamed from the media screen 111 or web server 203 each time a mouse-over operation is executed.

In some cases, a file containing the complete text-based description (e.g., a complete file) for a portion of digital content may be retrieved via a simple mouse-over operation from the media screen 111 or web server 203. Once retrieved, this complete file may be stored into a native data store residing on the one or more devices 102. Portions of this complete file may then be retrieved via a mouse over operation on an as needed basis, and displayed in the popup screen 504. As shown in FIG. 5, in some cases, portions of this complete file may be displayed without the corresponding digital content. In some cases, portions of this complete file may be displayed simultaneously with the digital content. This complete file may be an XML file, a character delimited flat file, for some other suitably formatted file.

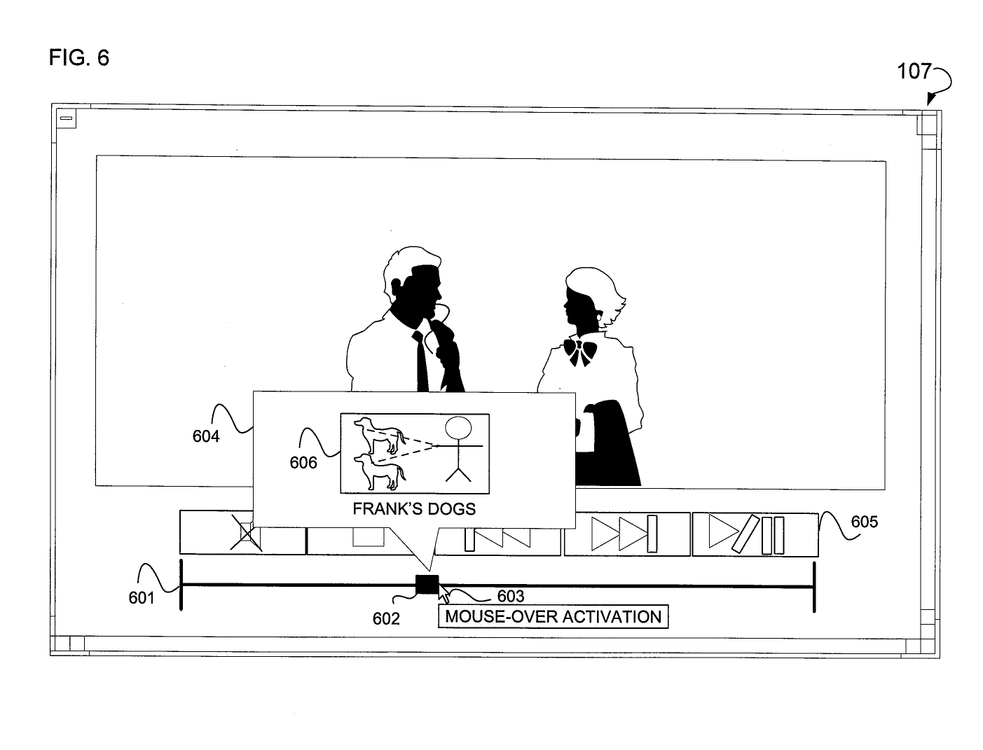

FIG. 6 is a diagram of an example media-player application UI 107 illustrating digital content in addition to a text-based description that may be displayed within a popup screen 604. Here an image 606 is displayed, in addition to text, within the popup screen 604. This image may be, for example, a JPEG formatted image, a PNG formatted image, GIF formatted image, or some other suitably formatted image. Icons may be displayed using one or more of these images and associated formats. This icon may be, for example, a trademark or service mark. An MPEG, or FLASH™ formatted portion of digital content may be displayed within the popup screen 604. In still further embodiments, a link formatted using HTML or XML may be displayed within the popup screen 604 to allow a user 101 or user 201 to access additional digital content from within the popup screen 604. Further, as with FIGS. 3 through 5, the user 101 or 201 may select a time position 602 existing along timeline toolbar 601 using a mouse pointer 603. The selection of this time position 602 may be in the form of a mouse-over operation that facilitates the display of the popup screen 604.

In some example embodiments, the popup screen 304, 404, 504, and 604 may be generated using technologies that include AJAX, DHTML, HTML, XML, or some other suitable technology. In some example cases, the popup screen 304 and 404 are generated as part of a stand-alone application written using Java, C#, C++, or some other suitable programming language.

In some example embodiments, a computer system is illustrated as having a UI 107, shown as part of a display, and a selection device. Further, a method of providing and selecting from a first and second frames (e.g., a primary frame and sub frame) in the display is also illustrated, the method comprising executing an operation to retrieve at least one time point related to a portion of digital content. Additionally, an operation is executed so as to display the at least one time point within the frame. An additional operation is executed to select the at least one time point from the frame using the selection device. An operation is executed to display a text-based description as part of the sub frame within the frame, the text-based description associated with an identifier value related to the at least one time point related to the portion of digital content. This method may also include the identifier value being a temporal reference value. Moreover, the method may include the sub frame created as a popup screen generated by a mouse-over operation. Also, the method may include the text-based description including at least one of text (see e.g., FIG. 3), an image (see e.g., FIG. 6), an icon, or a web link associated with the portion of digital content. Further, the method may include the sub frame being displayed as part of the frame, the frame appearing within a media-player application.

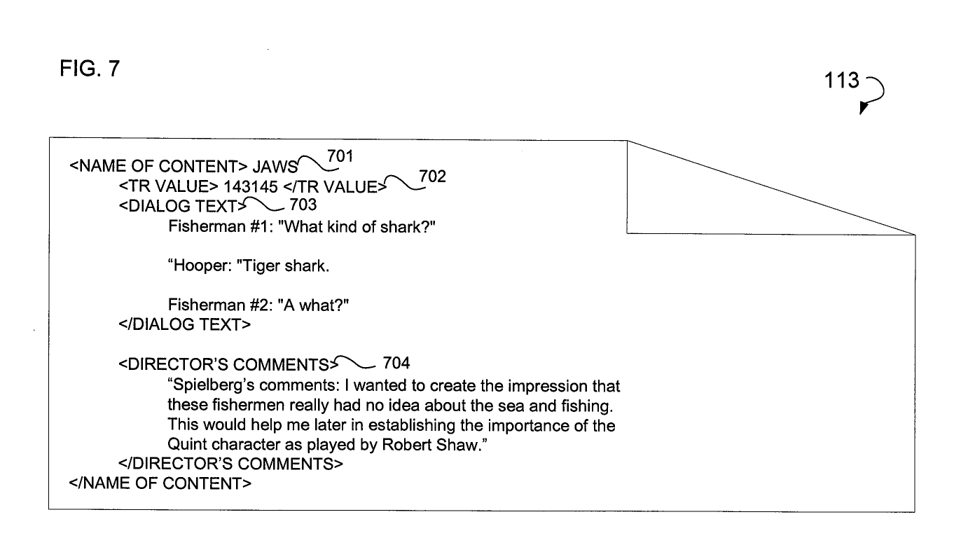

FIG. 7 is a diagram of an example text-based description 113 illustrating a text-based description 113 encoded in XML. Shown is a text-based description 113 encoded in XML, wherein contained within this XML are a number of XML tags denoting fields of data. For example, shown is a field 701 denoting the name of a particular portion of digital content. Here, for example, the name of the particular portion of digital content is “Jaws.” Further, field 702 is shown wherein this field 702 contains data relating to the time value associated with the particular scene. This time value may be, for example, a temporal reference value that is associated with a particular MPEG formatted data packet. A frame value or some other suitable identifier value may be used that denotes a time value associated with a particular portion of digital content. A portion of digital content may be an MPEG formatted data packet. Further, shown is a field 703 where this field 703 shows a text-based description such as a dialogue in a movie. A text-based description may be subtitles, closed-captioned-based dialogue, director's comments, actor's comments, chapter descriptions, hyperlinks, or any other suitable type of information may be disclosed. The text-based description may be some type of ASC-II, or Unicode based character(s).

As previously referenced, in addition to the field 703 containing a text-based description, a field 704 is shown that contains director's comments. Here, comments are provided by the director of the movie, “Jaws,” namely Steven Spielberg. The type of fields utilized within the text-based description 113 may be limited only by the needs of a particular user such as the user 101.

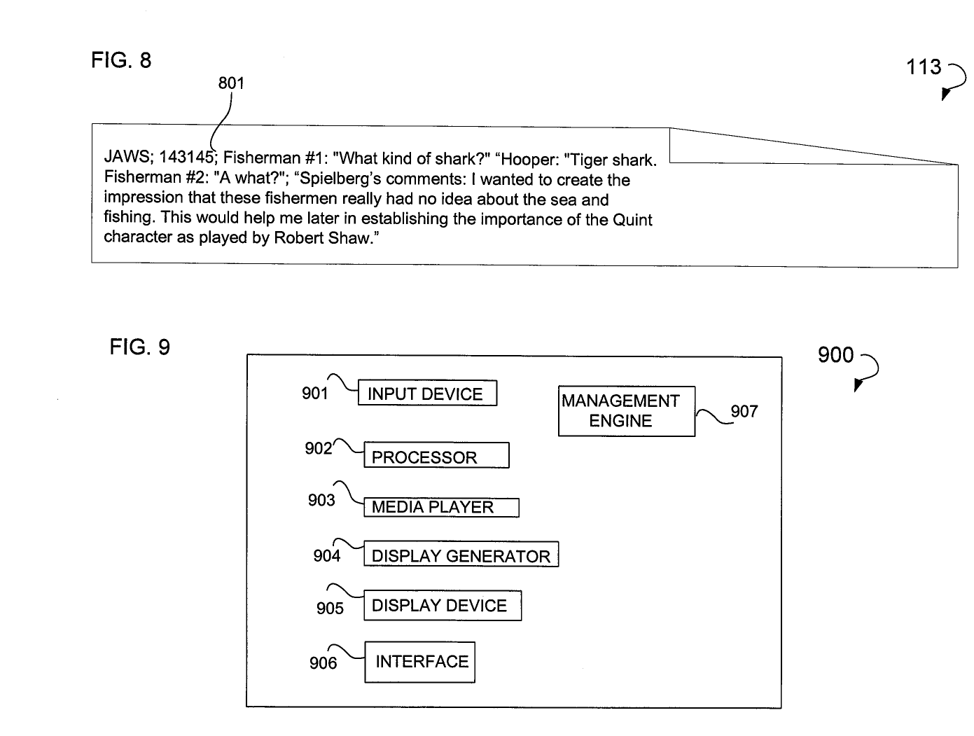

FIG. 8 is a diagram of an example text-based description 113 illustrating the use of a character delimited flat file as the basis for the text-based description 113. A text-based description 113 utilizes a character delimited flat file to denote the various fields of data to be shown within the media-player application and, more specifically, in a popup screen within the media-player application UI 107. Here, for example, the character delimiter is a semicolon (“;”) that serves to separate the various data fields within this text-based description 113. Other types of ASC-II or Unicode-based characters may be utilized to denote the various types of separate data fields contained within the text-based description 113.

In some example embodiments, the text-based description 113 may be an XML file, character delimited flat file, or some other suitably formatted file that contains all of the text associated with a particular portion of digital content. This text, as alluded to above, may be the dialog for a portion of digital content, subtitles, or other associated text. Where all the text associated with a particular portion of digital content is down loaded for playing, the media-player application may receive the associated text corresponding to the portion of digital content on an as needed basis. For example, if a user 101 requests information for a particular scene in a portion of digital content via a mouse-over operation, the media-player application may retrieve the requested text from a downloaded text-based description 113 residing on one or more of the devices 102. This in contrast to the one or more devices 102 having to request the text-base description 113 from another computer system every time a mouse-over operation is performed.

FIG. 9 is a block diagram of an example computer system 900 used to generate a text request and to receive a text-based description. This computer system 900 may be one of the one or more devices 102. Further, the blocks shown herein may be implemented in hardware, firmware, or software. Shown is computer system 900 comprising an input device 901. Also shown is at least one processor 902, where this at least one processor 902 may be a Central Processing Unit (CPU) having an x86 architecture, or some other suitable processor and associated architecture. This at least one processor 902 may be used to instantiate an input engine 903 to generate a signal based upon an input signal from the input device, the signal generated responsive to the selection of a time point associated with a portion of digital content. Further, the at least one processor 902 may be used to instantiate a media player 903. Additionally, a display generator 904 may be part of this computer system 900 and communicatively coupled to the media-player 903 to generate a display a frame containing a text-based description related to the portion of digital content, the text-based description associated with the time point. Moreover, a display device 905 may be utilized to present the display containing the text-base description. In some example embodiments, the display generator 904 may be used to transmit a temporal reference value to the media-player application. Some example embodiments may include, the processor 902 used to instantiate the display generator 904 based on at least one of AJAX code, or DHTML code. An interface 906 may be implemented to receive a data stream that includes the text-based description. This interface 906 may be an Application Programming Interface (API), or a socket programming defined interface wherein a port (e.g., software or hardware) is defined at which the data stream is to be received. In some cases, this interface 906 may be defined so as to receive a data stream that includes the text-based description, the data stream received from a device that includes at least one of a media server, streaming server, or a web server. In some example embodiments, the at least one processor 902 is to instantiate a management engine 907 to manage the data stream through an out-of-band protocol. An out-of-band protocol may be, for example, RTSP.

### Example Logic

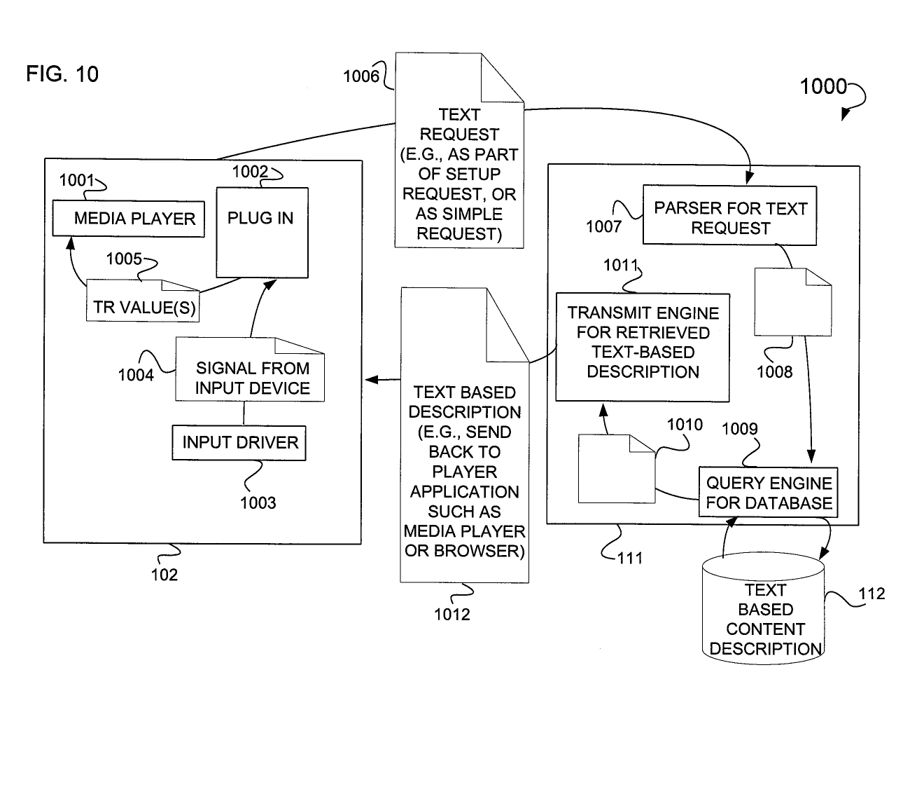

FIG. 10 is a software architecture diagram 1000 illustrating various code modules associated with the one or more devices 102, and the web server 111. These code modules may be written in a computer readable language, or may be implemented in hardware. These various code modules may reside as part of a media server, streaming server, or some other suitable server. Shown are the one or more devices 102 upon which reside various code modules. These code modules include, for example, a media-player 1001 application, a plug-in 1002, and input driver 1003. Also illustrated, are a number of code modules that reside on the web server 110. These modules include, for example, a parser 1007, a transmit engine 1011, and a query engine 1009. These various modules 1007, 1009, 809, and 1011 may reside upon the media server 111. In one example embodiment, a signal from an input device 1004 is generated and transmitted by an input driver 1003. The signal from the input driver 1004 is received by a plug-in 1002. This plug-in 1002 may, in turn, then extract various temporal reference values 1005 that may be a part of the signal input device 1004. In other example embodiments, the plug-in 1002 may perform a look-up of the temporal reference value(s) at the moment upon which that signal from the input device 1004 is received from the input driver 1003. A look-up may be an operation whereby the plug-in 1002 retrieves data from a persistent or non-persistent data store, the data relating to a temporal reference value, frame value, or other suitable value. The persistent or non-persistent data stores reside natively or non-natively relative to the one or more devices 102. The plug-in 1002 may either extracts the temporal reference value(s) or performs a look-up.

In some example embodiments, a temporal reference value 1005 is provided to a media-player application 1001. Upon receiving the temporal reference value 1005, the media-player application 1001 may generate a text request 1006. This text request 1006 may be sent as a part of a session setup such as session setup 109, or may be sent as a simple request for a text-based description, and the data associated therewith. In some example embodiments, a session setup may be a TCP/IP based session, wherein an IP connection results as part of the session setup. Some example cases may utilize UDP/IP in lieu of TCP/IP, such that no session setup occurs. A simple request may be formatted using, for example, the previously referenced HTTP or RTSP. This text request 1006 may, in some example embodiments, be received by a parser 1007 where this parser 1007 may act to parse the text request. Once parsed, a text description 1008 may be generated and sent to a query engine 1009. Once this text description 1008 is received by the query engine 1009, some type of query language such as SQL, or MDX language may be utilized to query the text-based content description database 112. Further, the text description 1008 itself may be formatted in SQL or MDX.

Once a query is provided to the text-based content description database 112, a result may be selected from the text-based content description database 112 and provided to the query engine 1009. The result may then be, for example, transmitted as a result 1010 to a transmit engine 1011, where this transmit engine 1011 which may generate a text-based description 1012. This text-based description 1012 may be considered as to be similar to the text-based description 113, or the text-based description 207. This text-based description 1012 is then provided to the one or more devices 102 for display within the media-player application UI 107 as part of a popup screen. The text-based description 1012 may encompass the entire text file for a portion of digital content that may be downloaded prior to the initiation of the streaming of digital content. The text-based description 1012 may encompass only a portion of the text corresponding to a portion of digital content. Further, images (e.g., JPEG, GIF etc.) or video (e.g., MPEG etc.) may be transmitted as part of the text-based description 1012. This text-based description may be formatted using HTTP/RTSP in combination with other protocols such as TCP/IP, or UDP/IP.

In some example embodiments, the plug-in 1002 may be a computer program that interacts with a host application (e.g., a media-player application, or a web browser), and extends the functionality of this host application. As used herein, the plug-in 1002 may also be a stand alone application that does not extend existing host application functionality, and that does not run within the content of a host program. A stand alone application may be written using C++, Java, C#, or some other suitable programming language.

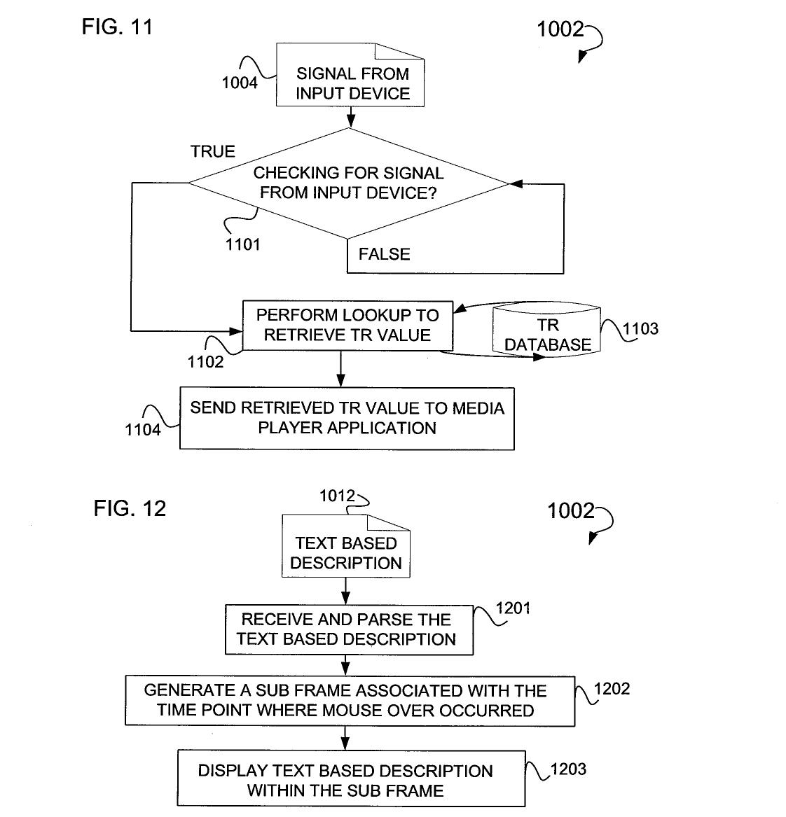

FIG. 11 is a flow chart illustrating an example method used to implement the plug-in 1002. Shown is an example method containing a number of operations 1101, 1102, 902, and 1104. Additionally shown a temporal reference database 1103. Illustrated is a decisional operation 1101 that checks for a signal from an input device. A signal from an input device 1004 may be detected through the execution of decisional operation 1101. In cases where the signal from an input device 1004 is detected, decisional operation 1101 evaluates to “true,” such that an operation 1102 is executed. Further, a loop may be formed when the decisional operation 1101 evaluates to “false,” such that another check for a signal from an input device may be performed. In cases where input device signal 804 is detected, decisional operation 901 evaluates to “true,” such that an operation 902 is executed. When executed, operation 1102 performs a lookup in a persistent or non-persistent data store (e.g., a temporal reference database 1103) for a temporal reference value associated with the signal from the input device 1004. Some example embodiments may include the plug-in not performing a lookup, but rather passing the signal from an input device 1004 to the media-player application 1001 so as to allow the signal from an input device 1004 to be processed by the media-player application 1001. Specifically, in some example embodiments, the various functionality illustrated in FIG. 11 may be implemented by the media-player application 1001. The temporal reference value is then retrieved from the temporal reference database 1103. Operation 1104 may be executed to send the retrieved temporal reference value to the media-player application 1001.

FIG. 12 is a flow chart illustrating an example method used to implement the plug-in 1002. The text-based description 1012 may be received and parsed through the execution of an operation 1201. Some example embodiments, may implement certain principles of socket programming so as to uniquely identify a port associated with the plug-in 1002. This port may allow the plug-in 1002 to receive data in the form of the text-based description 1012. Further, in some example embodiments, a grammar may be used to parse the text-based description 1012.

Some example embodiments may include the execution of an operation 1202 to generate a popup screen. This popup screen may be associated with a time point where a mouse-over occurs. Through executing operation 1003, the text-based description 1212, and the text contained therein, may be displayed within the popup screen. As illustrated elsewhere, the text contained within this text-based description 1012 may include text relating to a particular portion of digital content.

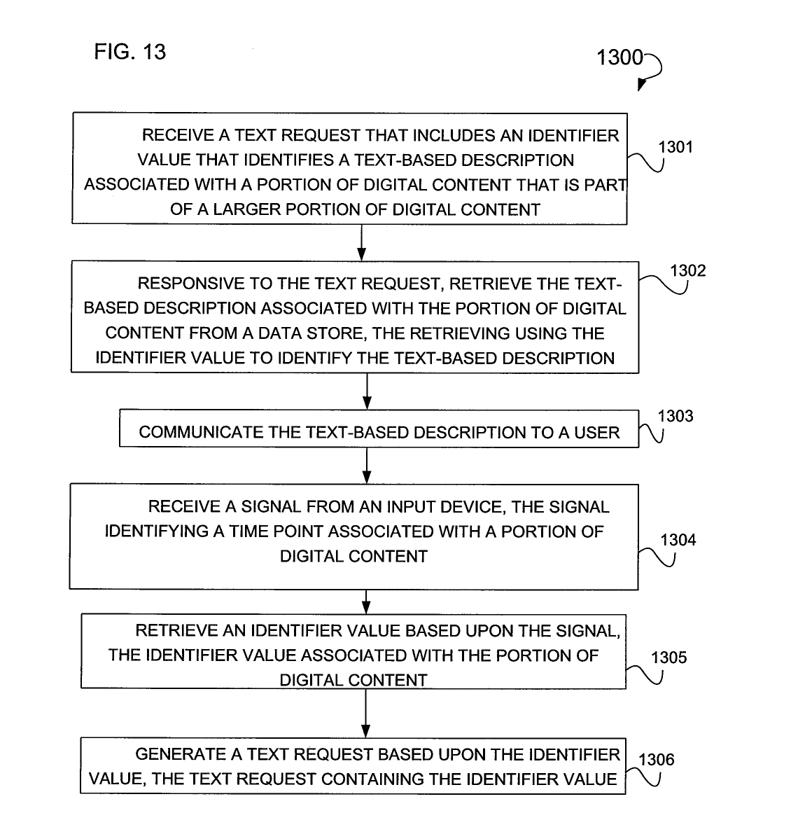

FIG. 13 is a flow chart illustrating an example method 1300 showing how to request and display a text-based description. Operations 1301 through 1303 may reside on, for example, a media server 111, or a web server 203. Illustrated is an example operation 1301 that when executed receives a text request that includes an identifier value that identifies a text-based description associated with a portion of digital content that is part of a larger portion of digital content. An operation 1302 may be executed that responsive to the text request, retrieves the text-based description associated with the portion of digital content from a data store, the retrieving using the identifier value to identify the text-based description. Further, an operation 1303 may be executed to communicate a text-based description to a user. In some example embodiments, the identifier value includes a temporal reference value. Additionally, the text-based description may be formatted using at least one of an XML formatted file, or a character delimited flat file. The text-based description may include at least one of text, an image, an icon, or a web link.

In some example embodiments, operations 1304 through 1306 may be executed on the one or more devices 102. An operation 1304 may be executed so as to receive a signal from an input device, the signal identifying a time point associated with a portion of digital content. Additionally, an operation 1305 may be executed to retrieve an identifier value based upon the signal, the identifier value associated with the portion of digital content. Operation 1306 may be executed to generate a text request based upon the identifier value, the text request containing the identifier value. In some example embodiments, the signal results from an execution of a mouse-over operation. Some example embodiments may include, the identifier value being generated by a plug-in associated with a media-player application. Further, the retrieving of the identifier value may be performed by looking up the identifier value in a data store. Additionally, the generating of the text request may include a media-player application transmitting the text request as part of a setup request.

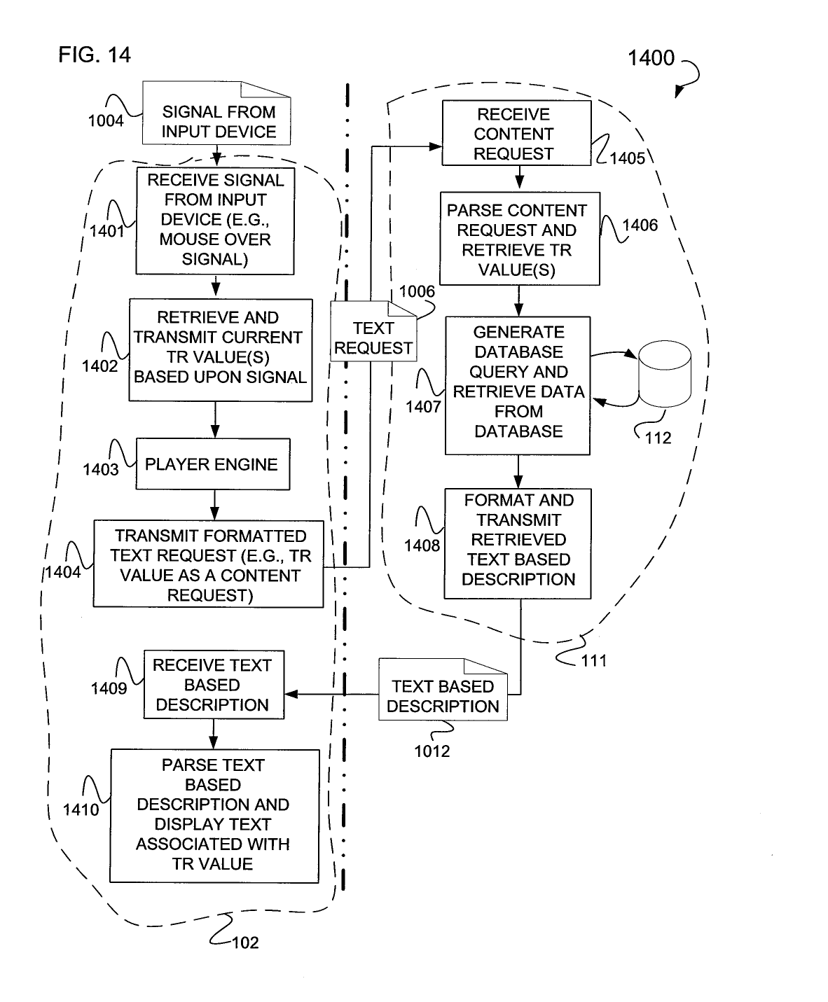

FIG. 14 is a dual-stream flow chart illustrating an example method 1400 that, when implemented, displays a text-based description within a media-player application UI 107. Existing as a part of the first stream of this dual-stream flow chart are a number of operations including operations 1401 through 1404, and operations 1409 and 1410. Further, existing as a second stream of this dual-stream flow chart are a number of additional operations including, for example, operations 1405 through 1408.

With regard to the first stream of the dual-stream flow chart, in some example embodiments, an operation 1401 is executed that receives a signal from an input device wherein this signal may be, for example, the previously referenced signal from input device 1004. This signal may be generated by virtue of a mouse-over operation being executed, or may be generated by some other action undertaken through the use of an input device. An operation 1402 may be executed, in some example embodiments, which may retrieve and transmit a current temporal reference value(s) based upon the receiving of the signal from the input device 1004. Once this temporal reference value(s) is retrieved, a player engine 1403 may be executed. Functionalities associated with this player engine 1403 will be more fully described below. An operation 1404 may also be executed, in some example embodiments, such that a formatted text request may be transmitted as a text request 1006. This text request 1006 may be received through the execution of an operation 1405. Further, an operation 1406 may be executed that parses the text request 1006 to retrieve the temporal reference value(s) contained therein. An operation 1407 may then be executed that then generates a database query (e.g., using SQL, or MDX) to retrieve data from the text-based content description database 112. An operation 1408 may be executed that formats the retrieved data and transmits it as a text-based description such as text-based description 1012, 113, or 107. This text-based description 1012 may then be received through the execution of operation 1409. An operation 1410 may then be executed that parses the text-based description 1012 and then displays the portions of the parsed text-based description 1012 within one or more of the previously described popup screens 304 or 404. The various operations, 1401 through 1404, and 1409 through 1410 may reside as a part of the one or more devices 102. Additionally, in some example embodiments, the various operations 1405 through 1408 and the associated text-based content description database 112 may reside as a part of, for example, the media server 111.

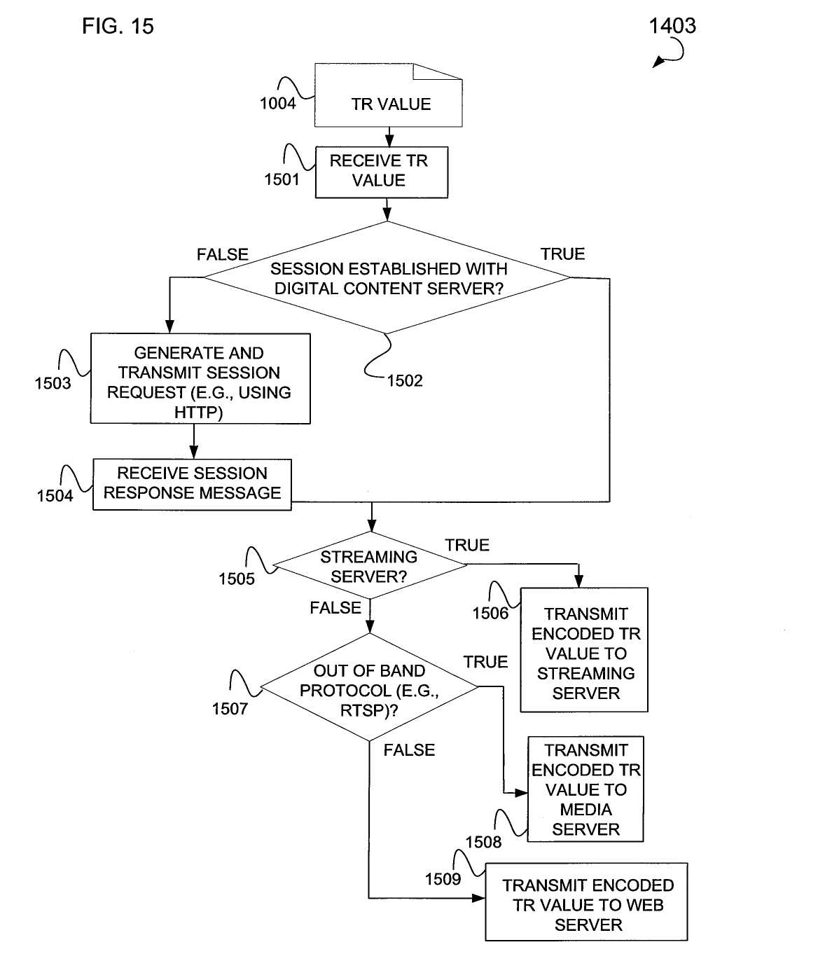

FIG. 15 is a flow chart illustrating an example method used to execute a player engine 1403. Shown are various operations associated with the operation 1413. For example, in some embodiments, an operation 1501 may be executed that receives the temporal reference value(s) 1004. Once received, a decisional operation 1502 is executed that determines whether or not a session setup 109 exists between the one or more devices 102 and, for example, a web server 110. In cases where decisional operation 1502 evaluates to “false,” an operation 1503 may be executed that generates and transmits a session request. This session request may be based upon, for example, HTTP. Further, an operation 1504 may be executed that receives a session response message from, for example, the web server 110. In cases where decisional operation 1502 evaluates to “true,” a further decisional operation 1505 is executed. This decisional operation 1505 may determine whether or not a session exists between the one or more devices 102 and a streaming server. In cases where decisional operation 1505 evaluates to “true,” a further operation 1506 is executed that transmits an encoded temporal reference value to the streaming server, before the method continues to operation 1308. In cases where decisional operation 1505 evaluates to “false,” a further decisional operation 1507 may be executed. This decisional operation 1507 may determine whether or not an out of band protocol is being utilized within the session. In cases where decisional operation 1507 evaluates to “true,” a further operation 1508 may be executed. This operation 1508 may transmit an encoded temporal reference value(s) to, for example, a media server. In cases where decisional operation 1507 evaluates to “false,” a further operation 1509 may be executed that transmits an encoded temporal reference value to a web server such as the previously referenced web server 110.

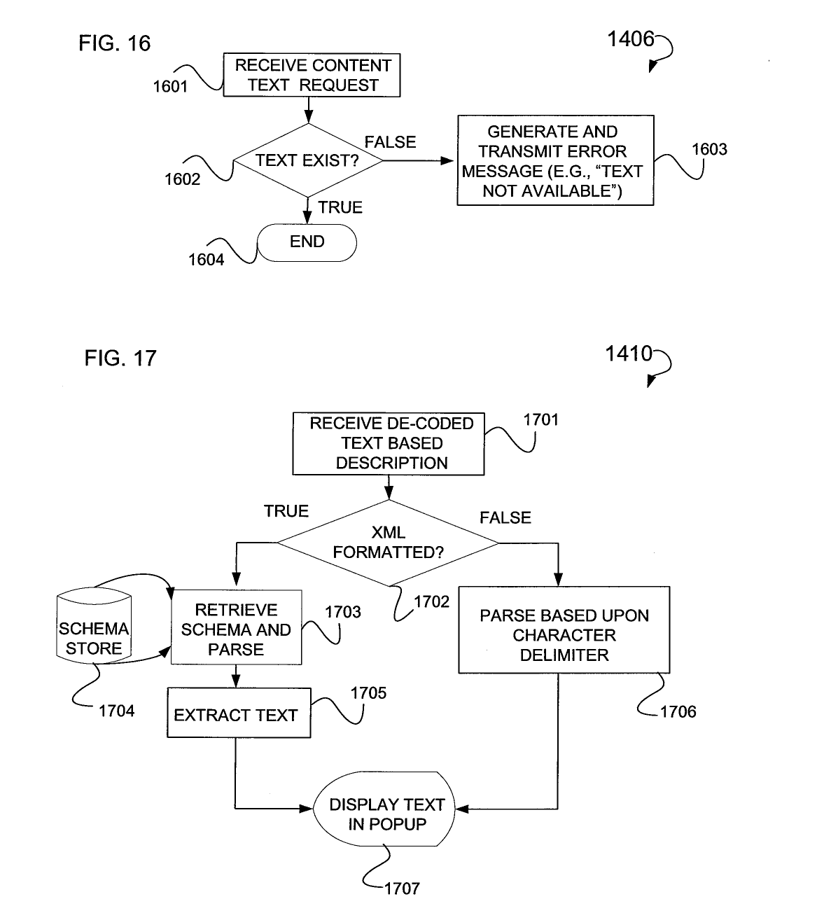

FIG. 16 is a flow chart illustrating an example method used to execute operation 1406. Illustrated is an operation 1601 that receives a content text request. This content text request may be a part of the text request 1006. A decisional operation 1602 may be executed that determines whether or not the requested text exists based upon a SQL or other query. In cases where decisional operation 1602 evaluates to “false,” an operation 1603 is executed. This operation 1603 may generate and transmit an error message stating that the text is not available. This operation 1603 may be executed in instances where, through the execution of decisional operation 1602, a lookup (e.g., an SQL based lookup) is conducted of the text request within the text-based content description database 112. In cases where this lookup fails and the requested text or text request does not exist within the text-based content description database 112, then the decisional operation 1602 evaluates to “false.” In cases where decisional operation 1602 evaluates to “true,” a determination condition 1604 is executed and the subsequent operations described in FIG. 14 are executed.

FIG. 17 is a flowchart illustrating an example method used to execute operation 1410. Shown is an operation 1701 that receives a decoded text-based description. A decisional operation 1702 may then be executed that determines whether or not the decoded text-based description is formatted using XML. In cases where decisional operation 1702 evaluates to “true,” a further operation 1703 is executed. This operation 1703 may retrieve a schema from schema store 1504 and may parse the text-based description utilizing the schema. Additionally, this schema may be an XML Schema Definition (XSD) or, in other example embodiments, it may be a Document Type Definition (DTD). Once the text-based description is parsed, an operation 1705 is executed that extracts the relevant text from the parsed text-based description. This relevant text may then be displayed in the previously referenced popup screens 303 or 404. In cases where decisional operation 1702 evaluates to “false,” an operation 1706 may be executed. This operation 1706 may parse the text-based description (see e.g., text-based description 1012) based upon some type of character delimiter. This character delimiter, as previously referenced, may be, for example, some type of ASC-II based or Unicode-based character utilized to distinguish various data fields such as data fields containing a text-based description.

### Example Database

Some embodiments may include the various databases (e.g., 112, 1103) being relational databases, or, in some cases, OLAP-based databases. In the case of relational databases, various tables of data are created and data is inserted into and/or selected from these tables using SQL or some other database-query language known in the art. In the case of OLAP databases, one or more multi-dimensional cubes or hyper cubes, containing multidimensional data from which data is selected from or inserted into using MDX, may be implemented. In the case of a database using tables and SQL, a database application such as, for example, MYSQL™, MICROSOFT SQL SERVER™, ORACLE 8I™, 10G™, or some other suitable database application may be used to manage the data. In this, the case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. The tables or cubes made up of tables, in the case of, for example, ROLAP, are organized into an RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization, or optimization algorithm known in the art.

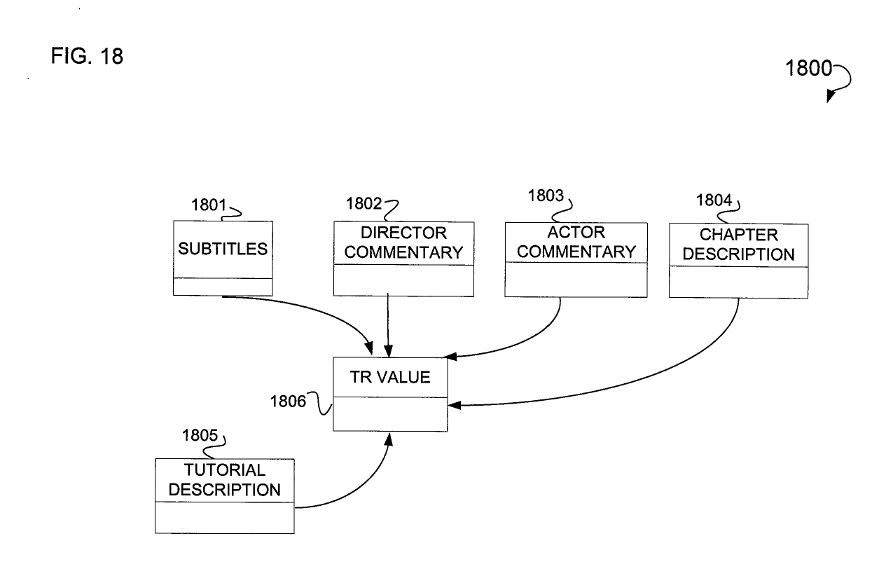

FIG. 18 is an example RDS 1800. Shown are a variety of tables and relationships between these tables. These tables, in some example embodiments, contain data relating to the text-based descriptions. This data may be contained in, for example, the text-based content description database 112. Table 1801 may be implemented, wherein this table 1801 may contain subtitles associated with a particular portion of digital content. Table 1802 may be implemented, wherein this table 1802 contains director commentary. Additionally, a table 1803 may be implemented, wherein this table 1803 contains actor commentary. Further, a table 1804 may be implemented that contains chapter descriptions, wherein the chapter description has a textual description of a particular portion of a particular portion of digital content. A table 1805 may be implemented that contains a tutorial description. Mapped to the data contained in each of the previously referenced tables (e.g., table 1801 through table 1805) are a number of temporal reference values. These temporal reference values may be contained in the table 1806. The temporal reference value may be used to uniquely distinguish the data contained in each of the tables 1801 through 1805. The temporal reference values contained in the table 1806 may be used in conjunction with some other type of unique identifier. This unique identifier may be some type of unique integer value that they may also be associated with the data contained in each of various tables 1801 through 1805. The data contained in the tables 1801 through 1805 may be anyone of a number of suitable data types. These suitable data types may include, for example, a string data type, a character data type, an XML data type, or some other suitable data type that may be used to represent text in a text-based description. In some example embodiments, the temporal reference value contained in the table 1806 may be an integer data type or some other suitable data type.

### Component Design

Some example embodiments may include the above-illustrated operations being written as one or more software components. These components, and the functionality associated with each, may be used by client, server, or peer computer systems. These various components can be implemented into the system on an as-needed basis. These components may be written in an object-oriented computer language such that a component oriented or object-oriented programming technique can be implemented using a Visual Component Library (VCL), Component Library for Cross Platform (CLX), Java Beans (JB), Enterprise Java Beans (EJB), Component Object Model (COM), or Distributed Component Object Model (DCOM)), or other suitable technique. These components are linked to other components via various Application Programming Interfaces (APIs) and then compiled into one complete server and/or client application. The method for using components in the building of client and server applications is well known in the art. Further, these components may be linked together via various distributed programming protocols as distributed computing components.

### Distributed Computing Components and Protocols

Some example embodiments may include remote procedure calls being used to implement one or more of the above-illustrated components across a distributed programming environment. For example, a logic level may reside on a first computer system that is remotely located remotely from a second computer system containing an interface level (e.g., a GUI). These first and second computer systems can be configured in a server-client, peer-to-peer, or some other configuration. The various levels can be written using the above-illustrated component design principles and can be written in the same programming language or in different programming languages. Various protocols may be implemented to enable these various levels and the components contained therein to communicate regardless of the programming language used to write these components. For example, an operation written in C++ using Common Object Request Broker Architecture (CORBA) or Simple Object Access Protocol (SOAP) can communicate with another remote module written in Java™. Suitable protocols include SOAP, CORBA, and other protocols well-known in the art.

### A System of Transmission Between a Server and Client

Some embodiments may utilize the OSI model or TCP/IP protocol stack model for defining the protocols used by a network to transmit data. In applying these models, a system of data transmission between a server and client, or between peer computer systems, is illustrated as a series of roughly five layers comprising: an application layer, a transport layer, a network layer, a data link layer, and a physical layer. In the case of software having a three tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology) or structures.

### A Computer System

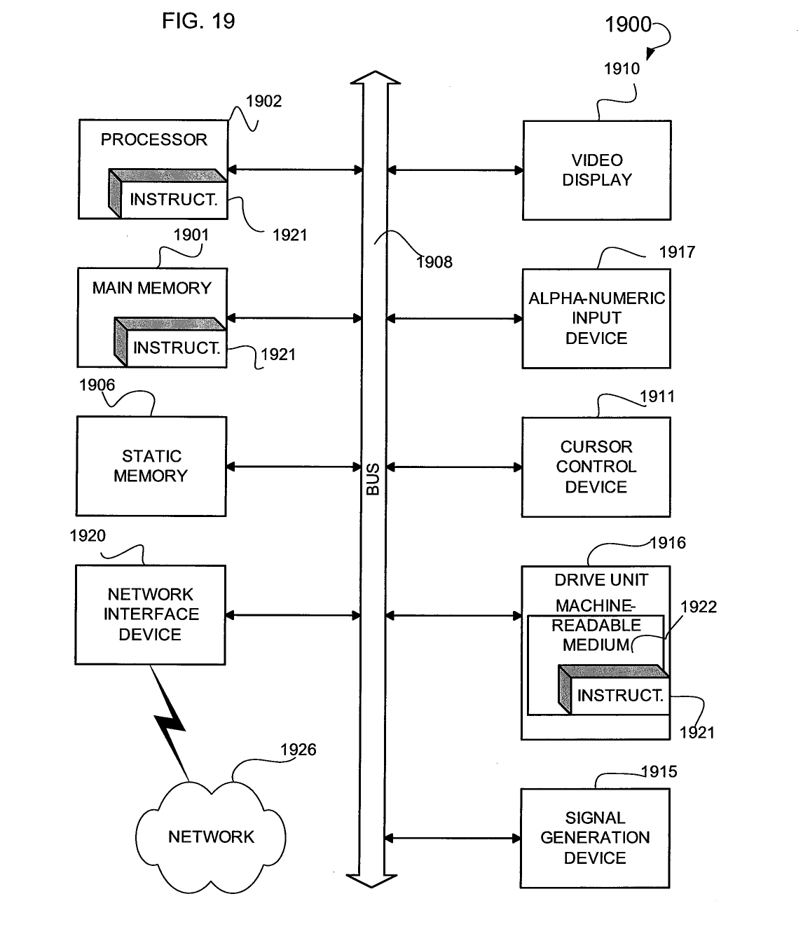

FIG. 19 shows a diagrammatic representation of a machine in the example form of a computer system 1900 that executes a set of instructions to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a PC, a tablet PC, a Set-Top Box (STB), a PDA, a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 1900 includes a processor 1902 (e.g., a CPU, a Graphics Processing Unit (GPU) or both), a main memory 1901, and a static memory 1906, which communicate with each other via a bus 1908. The computer system 1900 may further include a video display unit 1910 (e.g., a Liquid Crystal Display (LCD) or a Cathode Ray Tube (CRT)). The computer system 1900 also includes an alphanumeric input device 1917 (e.g., a keyboard), a UI cursor controller 1911 (e.g., a mouse), a drive unit 1916, a signal generation device 1915 (e.g., a speaker) and a network interface device (e.g., a transmitter) 1920.

The disk drive unit 1916 includes a machine-readable medium 1922 on which is stored one or more sets of instructions and data structures (e.g., software) 1921 embodying or used by any one or more of the methodologies or functions illustrated herein. The software instructions 1921 may also reside, completely or at least partially, within the main memory 1901 and/or within the processor 1902 during execution thereof by the computer system 1900, the main memory 1901 and the processor 1902 also constituting machine-readable media.

The instructions 1921 may further be transmitted or received over a network 1926 via the network interface device 1920 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies illustrated herein. The term “machine-readable medium” shall accordingly be taken to include, but not be limited to, solid-state memories, optical and magnetic media, and carrier wave signals.

### Marketplace Applications

In some example embodiments, a system and method is illustrated that allows for a text-based description to be provided in a sub frame in a display. This display may be part of a media-player application. The text-based description may include text relating to digital content and may include text relating to subtitles, director's comments, actor's comments, or a scene description associated with the portion of digital content. In one example embodiment, the sub frame may be a popup screen, or popup, wherein the text is displayed in the popup that is associated with a time point in the in the digital content. This text-based description may be streamed to the user, without the user having to download the entire portion of digital content, or even all of the text-based description as it relates to other time points for the digital content.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1-4. (canceled)

5. A computer implemented method comprising:
receiving a signal, the signal identifying a time point associated with a portion of digital content, the digital content being streamed to a client device and a portion of the digital content not yet streamed to the client device;
retrieving an identifier value based upon the time point in the signal, the identifier value associated with the portion of the digital content not yet streamed;
generating, using one or more processors, a text request based upon the identifier value, the text request containing the identifier value;
in response to the text request, retrieving a text-based description file for the portion of the digital content not yet streamed, the text-based description file including a subtitle of spoken dialogue in the portion of the digital content associated with the time point; and
transmitting the text-based description file for only the portion of the digital content not yet streamed to the client device for display.

6. The computer implemented method of claim 5, wherein the signal results from an execution of a mouse-over operation.

7. The computer implemented method of claim 5, including generating the identifier value using a plug-in associated with a media-player application.

8. The computer implemented method of claim 5, wherein the retrieving of the identifier value is performed by looking up the identifier value in a data store.

9. The computer implemented method of claim 5, wherein the generating of the text request includes a media-player application transmitting the text request as part of a setup request.

10-14. (canceled)

15. A computer system comprising:
an input device;
at least one processor to instantiate:
an input engine to generate a signal based upon an input signal from the input device, the signal generated responsive to a selection of a time point y associated with a portion of digital content, the time point y corresponding to a time in the digital content that is later than a time point x corresponding to a time in the digital content currently being streamed to the computer system, the time point y further corresponding to a portion of the digital content not yet streamed to the computer system, the time point y selected from a timeline toolbar displayed in a user interface;
a media player to download a text-based description file for only the portion of the digital content not yet streamed to the client device, the text-based description file including a subtitle of spoken dialogue in the portion of the digital content associated with the time point; and
a display generator communicatively coupled to the media player to display the text-based description related to the portion of digital content not yet streamed along with display of the digital content corresponding to the time point x;
a native data store to locally store a text-based description file including the text-based description for the portion of the digital content, the text-based description file being retrieved based on a first text request for the digital content at the time point; and
a display device to display the text-based description.

16. The computer system of claim 15, wherein the display generator is further configured to transmit a temporal reference value to the media-player application.

17. The computer system of claim 15, wherein the processor is to instantiate the display generator based on at least one of Asynchronous JavaScript and XML (AJAX) code, or Dynamic Hyper Text Markup Language (DHTML) code.

18. The computer system of claim 15, further comprising an interface to receive a data stream that includes the text-based description.

19. The computer system of claim 15, wherein the at least one processor is further configured to instantiate a management engine to manage the data stream through an out-of-band protocol.

20. The computer system of claim 15, further comprising an interface to receive a data stream that includes the text-based description, the data stream received from a device that includes at least one of a media server, streaming server, or a web server.

21. (canceled)

22. A non-transitory machine-readable medium comprising instructions, which when implemented by at least one processor of a machine, cause the machine to perform operations comprising:
receiving a signal, the signal identifying a time point associated with a portion of digital content, the digital content being streamed to a client device and a portion of the digital content not yet streamed to the client device;
retrieving an identifier value based upon the time point in the signal, the identifier value associated with the portion of the digital content not yet streamed;
generating, using one or more processors, a text request based upon the identifier value, the text request containing the identifier value;
in response to the text request, retrieving a text-based description file for the portion of the digital content not yet streamed, the text-based description file including a subtitle of spoken dialogue in the portion of the digital content associated with the time point; and
transmitting the text-based description file for only the portion of the digital content not yet streamed to the client device for display.

23. The non-transitory machine-readable medium of claim 22, wherein the text-based description file further comprises at least one of director commentary or actor commentary.

24. The non-transitory machine-readable medium of claim 22, wherein the operations further comprise displaying a text-based description from the text-based description file in a sub-frame of a larger frame displaying the portion of the digital content.

25. The non-transitory machine-readable medium of clam 24, wherein the sub-frame is attached to the timeline toolbar used to select the time point.

26. The non-transitory machine-readable medium of claim 22, wherein the operations further comprise displaying the textual representation of the audio portion in a sub-frame of a larger frame displaying the portion of the digital content.

27. The non-transitory machine-readable medium of clam 22, wherein the textual representation of an audio portion comprises one of a close-captioned text or subtitles.

28. The computer implemented method of claim 5, further comprising displaying a text-based description from the text-based description file in a sub-frame of a larger frame displaying the portion of the digital content.

29. The computer implemented method of claim 28, wherein the sub-frame is attached to the timeline toolbar used to select the time point.

30. The computer implemented method of claim 5, further comprising displaying the textual representation of the audio portion in a sub-frame of a larger frame displaying the portion of the digital content.

31. The computer implemented method of claim 5, wherein the comprises a written translation of the spoken dialogue in a foreign language.

32. The computer implemented method of claim 5, wherein the subtitle comprises a written rendering in a same language as the spoken dialogue.
